(19) United States
(12) Patent Application Publication
(10) Pub. No.: US 2006/0121380 A1
(43) Pub. Date: Jun. 8, 2006

(54) Toner compositions

(75) Inventors: Vladislav Skorokhod, Mississauga (CA); Wafa Faisul Bashir, Mississauga (CA); Maria N. V. McDougall, Burlington (CA); Shigang (Steven) Qiu, Toronto (CA)

Correspondence Address: Marylou J. Lavoie, Esq. LLC, 1 Banks Road, Simsbury, CT, 06070, US

(73) Assignee: Xerox Corporation

(21) Appl. No.: 11/003,297

(22) Filed: Dec. 3, 2004

(51) Int. Cl. G03G 9/09

(52) U.S. Cl. 430/106.2; 430/108.1; 430/109.1; 430/111.41; 430/109.3; 430/137.14; 430/106.1

(57) ABSTRACT

Toner compositions are described comprising a resin substantially free of cross linking; a cross linked resin; a wax; and a conductive colorant.

### RELATED APPLICATIONS

Commonly assigned, co-pending U.S. patent application of Raj D. Patel, Daryl Vanbesien, Enno E. Agur, Edward G. Zwartz, Maria N. V. McDougall, Emily L. Moore, Patricia A. Burns, Kimberly D. Nosella, Kelly Zhou, Vladislav Skorokhod, Wafa F. Bashir, and Shigang Steven Qiu, Ser. No. ______, Attorney Docket Number A3307-US-NP, entitled “Toner Composition,” filed of even date herewith, which is hereby incorporated by reference herein in its entirety, describes a toner composition and process, such as, for example, an emulsion aggregation toner process for preparing a toner comprising a resin substantially free of cross linking, a cross linked resin or gel, wax, and colorant.

Commonly assigned, co-pending U.S. patent application of Edward Graham Zwartz, T. Brian McAneney, Daryl Vanbesien, Patricia Burns, and Hwee Ng, Ser. No. ______, Attorney Docket Number A3310-US-NP, entitled “Toner Composition,” filed of even date herewith, which is hereby incorporated by reference herein in its entirety, describes a toner composition comprising non cross linked resin, cross linked resin, wax, pigment dispersion, and a coagulant of a poly metal halide providing a toner having desirable characteristics such as excellent fusing characteristics.

Commonly assigned, co-pending U.S. patent application of Edward Graham Zwartz and T. Brian McAneney, Ser. No. ______, Attorney Docket Number 20040601-US-NP, entitled “Toner Processes,” filed of even date herewith, which is hereby incorporated by reference herein in its entirety, describes toner processes comprising developing an image on a document having a toner composition applied to the document, wherein the toner composition comprises a resin substantially free of cross linking, a cross linked resin or gel, a wax, and a colorant; and wherein the developed document possesses the characteristic of resistance to adverse effects of electron beam irradiation. In embodiments, the process further includes, during fusing, migrating the wax and cross linked resin or gel to the surface of the toner particles thereby imparting protection to the toner particles against exposure to elevated temperatures.

Commonly assigned, co-pending U.S. patent application of Maria N. V. McDougall and Richard P. N. Veregin, Ser. No. ______, Attorney Docket Number DA2370, entitled “Toner Compositions” filed of even date herewith, which is hereby incorporated by reference herein in its entirety, describes a toner composition comprising a binder, colorant, and a charge control surface additive mixture comprising a mixture of a first titanium dioxide possessing a first conductivity and a second titanium dioxide possessing a second conductivity and which second conductivity is dissimilar from the first conductivity; wherein the mixture of the first titanium dioxide and the second titanium dioxide is selected in a ratio sufficient to impart a selected triboelectric charging characteristic to the toner composition.

The appropriate components and process aspects of each of the foregoing may be selected for the present toner compositions in embodiments thereof.

### TECHNICAL FIELD

The present disclosure relates to a toner composition and more particularly relates to an emulsion aggregation black toner composition that is particularly suitable for high speed printers and further more particularly relates to an emulsion aggregation toner having an optimized carbon black pigment loading for improved image quality in combination with reduction or elimination of undesirable effects associated with inductive charging.

### BACKGROUND

For both black and color prints, a small particle size toner is known to improve the image quality of the prints. High speed black and white printers require toner particles that can provide a matte finish in an oil-less fuser system with a low minimum fixing temperature (MFT) to enable high speed printing and at the same time achieve superior image quality in the resultant printed product.

It is known that toners containing carbon black or other conductive pigments are susceptible to inductive charging in high electric fields. As a result, a large amount of wrong-sign toner is created which leads to excessive background on the photoreceptor especially with machines employing contact dual-component development. This inductive background has low transfer efficiency and causes two fundamental problems: poor image quality due to some background toner transferring onto the media, and an excessive amount of wasted toner, since most of the un-transferred background toner is directed straight to the waste bottle. Under the most severe conditions, as much as about 80% of the total toner consumed can be lost to inductive background.

U.S. Pat. No. 6,447,974 describes in the Abstract a process for the preparation of a latex polymer by (i) preparing or providing a water aqueous phase containing an anionic surfactant in an optional amount of less than or equal to about 20 percent by weight of the total amount of anionic surfactant used in forming the latex polymer; (ii) preparing or providing a monomer emulsion in water which emulsion contains an anionic surfactant; (iii) adding about 50 percent or less of said monomer emulsion to said aqueous phase to thereby initiate seed polymerization and to form a seed polymer, said aqueous phase containing a free radical initiator; and (iv) adding the remaining percent of said monomer emulsion to the composition of (iii) and heating to complete an emulsion polymerization thus forming a latex polymer.

U.S. Pat. No. 6,413,692 describes in the Abstract a process comprising coalescing a plurality of latex encapsulated colorants and wherein each of said encapsulated colorants are generated by miniemulsion polymerization.

U.S. Pat. No. 6,309,787 describes in the Abstract a process comprising aggregating a colorant encapsulated polymer particle containing a colorant with colorant particles and wherein said colorant encapsulated latex is generated by a miniemulsion polymerization.

U.S. Pat. No. 6,294,306 describes in the Abstract toners which include one or more copolymers combined with colorant particles or primary toner particles and a process for preparing a toner comprising (i) polymerizing an aqueous latex emulsion comprising one or more monomers, an optional nonionic surfactant, an optional anionic surfactant, an optional free radical initiator, an optional chain transfer agent, and one or more copolymers to form emulsion resin particles having the one or more copolymers dispersed therein; (ii) combining the emulsion resin particle with colorant to form statically bound aggregated composite particles; (iii) heating the statically bound aggregated composite particles to form toner; and (iv) optionally isolating the toner.

U.S. Pat. No. 6,130,021 describes in the Abstract a process involving the mixing of a latex emulsion containing resin and a surfactant with a colorant dispersion containing a nonionic surfactant, and a polymeric additive and adjusting the resulting mixture pH to less than about 4 by the addition of an acid and thereafter heating at a temperature below about, or equal to about the glass transition temperature (Tg) of the latex resin, subsequently heating at a temperature above about, or about equal to the Tg of the latex resin, cooling to about room temperature, and isolating the toner product.

U.S. Pat. No. 5,928,830 describes in the Abstract a process for the preparation of a latex comprising a core polymer and a shell thereover and wherein the core polymer is generated by (A) (i) emulsification and heating of the polymerization reagents of monomer, chain transfer agent, water, surfactant, and initiator; (ii) generating a seed latex by the aqueous emulsion polymerization of a mixture comprised of part of the (i) monomer emulsion, from about 0.5 to about 50 percent by weight, and a free radical initiator, and which polymerization is accomplished by heating, and, wherein the reaction of the free radical initiator and monomer produces a seed latex containing a polymer; (iii) heating and adding to the formed seed particles of (ii) the remaining monomer emulsion of (I), from about 50 to about 99.5 percent by weight of monomer emulsion of (i) and free radical initiator; (iv) whereby there is provided said core polymer; and (B) forming a shell thereover said core generated polymer and which shell is generated by emulsion polymerization of a second monomer in the presence of the core polymer, which emulsion polymerization is accomplished by (i) emulsification and heating of the polymerization reagents of monomer, chain transfer agent, surfactant, and an initiator; (ii) adding a free radical initiator and heating; (iii) whereby there is provided said shell polymer.

U.S. Pat. No. 5,869,558 describes in the Abstract dielectric black particles for use in electrophoretic image displays, electrostatic toner or the like, and the corresponding method of manufacturing the same. The black particles are latex particles formed by a polymerization technique, wherein the latex particles are stained to a high degree of blackness with a metal oxide.

U.S. Pat. No. 5,869,216 describes in the Abstract a process for the preparation of toner comprising blending an aqueous colorant dispersion and a latex emulsion containing resin; heating the resulting mixture at a temperature below about the glass transition temperature (Tg) of the latex resin to form toner sized aggregates; heating said resulting aggregates at a temperature above about the Tg of the latex resin to effect fusion or coalescence of the aggregates; redispersing said toner in water at a pH of above about 7; contacting the resulting mixture with a metal halide or salt, and then with a mixture of an alkaline base and a salicylic acid, a catechol, or mixtures thereof at a temperature of from about 25 degrees Celsius to about 80 degrees Celsius; and optionally isolating the toner product, washing, and drying. Additional patents of interest include U.S. Pat. No. 5,766,818; U.S. Pat. No. 5,344,738; and U.S. Pat. No. 4,291,111.

The disclosures of each of the foregoing U.S. Patents are totally incorporated herein by reference in their entireties. The appropriate components and process aspects of each of the foregoing U.S. Patents may be selected for the disclosure in embodiments thereof.

There remains a need for an improved toner composition and process which overcomes or alleviates the above described and other problems experienced in the art. There further remains a need for a toner composition suitable for high speed printing, particularly high speed monochrome printing that can provide excellent release and hot offset characteristics, minimum fixing temperature, and suitable small toner particle size characteristics.

### SUMMARY

A toner composition is described comprising a resin substantially free of cross liking (also referred to herein as a non cross linked resin); a cross linked resin or gel; a wax; and a conductive colorant. In embodiments, the composition has an optimized colorant loading to provide excellent image quality in combination with alleviation or elimination of undesirable effects associated with inductive charging.

A process for preparing a toner is described comprising mixing a resin substantially free of cross linking and a cross-linked resin in the presence of a wax, a colorant, and a coagulant to provide toner size aggregates; adding additional resin substantially free of cross linking to the formed aggregates thereby providing a shell over the formed aggregates; heating the shell covered aggregates to form toner; and, optionally, isolating the toner. In embodiments, the heating comprises a first heating below the glass transition temperature of the resin substantially free of cross linking and a second heating above the glass transition temperature of the resin substantially free of cross linking.

In embodiments, the colorant is a conductive colorant present in an amount of about 4% to about 18% by weight based upon the weight of the toner composition. In further embodiments, the colorant is a conductive colorant present in an amount of from about 6% to about 10% or about 8% to about 9% by weight based upon the weight of the toner composition. In further embodiments, the colorant has a volume average particle diameter of about 50 to about 300 nanometers. In still further embodiments, the colorant is a conductive pigment, black pigment, or carbon black. As used herein, conductive colorant means, for example, a colorant having a conductivity of about 1×10⁻⁶ Siemens per centimeter (S/cm) to about to about 1×10⁴ S/cm or about 1×10⁻² S/cm to about 100 S/cm or about 0.1 S/cm to about 10 S/cm. Conductivity is measured by any suitable method such as for example ASTM Standard Test Method for Resistivity of Electrical Conductor Materials ASTM B193-02 or ASTM Power Resistivity Test WK5909.

In embodiments, the toner composition provides for example an emulsion aggregation toner having a nominal transferred toner mass per area (TMA) of about 0.35 to about 0.55 mg/cm². Nominal TMA is defined as such that the resulting image possesses a desired level of color density. For example, for monochrome (black and white) images the desired level of luminosity can be about 19 to about 25 or about 20 to about 23.

In further embodiments, the toner composition provides a toner, for example an emulsion aggregation toner, having a mottle grade of about 25 to about 35.

In yet further embodiments, the toner composition provides a toner, for example an emulsion aggregation toner, having a graininess mottle grade of about 4 to about 5.

In still further embodiments, the toner composition provides for example an emulsion aggregation toner having a nominal development voltage of about 200 V to about 300 V. Development voltage is defined as the difference of electrostatic potentials between the developer and the image area of the photoreceptor required to produce the corresponding nominal TMA.

In further embodiments, the toner composition provides for example an emulsion aggregation toner having a photoreceptor background of less than about 60 particles/mm² for monochrome applications.

The present toner provides, in aspects, characteristics which meet reprographic machine requirements such as minimum fixing temperature, wide fusing latitude, good release properties, low gloss, robust particles, desirable triboelectrical properties, and development at high speeds such as speeds of 150 ppm (i.e., letter-size one-sided prints per minute) and above. In embodiments, the toner provides a range of colorant, for example conductive pigment such as carbon black, that can be employed, for example, in two-component magnetic brush development for monochrome applications to provide excellent image quality while at the same time minimizing or eliminating undesirable effects associated with inductive charging.

In embodiments, a developer is provided for example comprising the present compositions and a carrier. In embodiments, devices for preparing an image are provided wherein the device employs the present compositions. For example, a xerographic device comprises a charging component, an imaging component, a photoconductive component, a developing component, a transfer component, and a fusing component, and wherein the development component comprises the present developer. In further embodiments, devices comprising high speed printers, black and white high speed printers, color printers, or combinations thereof, are provided.

These and other features and advantages will be more fully understood from the following description of certain specific embodiments taken together with the accompanying claims.

### DESCRIPTION

A toner composition comprising a non cross linked resin; a cross linked resin or gel; a wax; and a colorant has an optimized colorant loading to provide excellent image quality in combination with alleviation or elimination of undesirable effects associated with inductive charging. Further provided is a toner process comprising mixing a non-cross linked resin and a cross linked resin or gel in the presence of a wax, a colorant, and coagulant to provide toner sized aggregates; wherein the colorant is present in an amount sufficient to provide excellent image quality in combination with alleviation or elimination of undesirable effects associated with inductive charging; adding additional non cross linked latex to the formed aggregates thereby providing a shell over the formed aggregates; heating the shell covered aggregates to form toner; and, optionally, isolating the toner.

The process provides in embodiments thereof providing an anionic surfactant in an amount of about 0.01% to about 20% by weight based upon a total weight of the reaction mixture; wherein the anionic surfactant is selected from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof. Further provided in embodiments is a toner process wherein the shell has a thickness of about 0.3 to about 0.8 micrometers.

Further provided are imaging processes comprising developing an image on a photoreceptor with a toner composition as described herein.

For example, the non cross linked resin comprises a resin substantially free of cross linking such as a resin having substantially about zero percent cross linking to about 0.1 percent cross linking. For example, the cross linked resin or gel comprises a resin or gel that is cross linked, for example, having about 0.3% to about 20% percent cross linking.

As used herein, the resin substantially free of cross linking means for example a resin having substantially zero percent cross linking to less than about 0.1 percent cross linking. In embodiments, the cross linked resin or gel comprises a cross linked resin or gel having for example about 0.3 percent to about 20 percent cross linking.

In embodiments, the toner composition comprises about 68% to about 75% resin substantially free of cross linking, about 6% to about 13% cross linked resin, about 6% to about 12% wax, and about 4% to about 18% conductive colorant, by weight based upon the total weight of the composition and wherein the total of said components is about 100%.

In embodiments, the colorant is a pigment, for example a conductive pigment such as carbon black, present in an amount of about 4% to about 18%, or about 6% to about 10%, or about 8% to about 9%, by weight based upon the weight of the toner composition.

In embodiments, the toner composition provides an emulsion aggregation toner having a nominal transferred toner mass per area (TMA) of about 0.35 to about 0.55 mg/cm².

In embodiments, the toner composition provides an emulsion aggregation toner having a mottle grade of about 25 to about 35.

In further embodiments, the toner composition provides an emulsion aggregation toner having a graininess mottle grade of about 4 to about 5.

In further embodiments, the toner composition provides an emulsion aggregation toner having a nominal development voltage of about 200 V to about 300 V.

In further embodiments, the toner composition provides an emulsion aggregation toner having a photoreceptor background of less than about 60 particles/mm².

Latex Resins or Polymers

Illustrative examples of latex resins or polymers selected for the non cross linked resin and cross linked resin or gel include known polymers such as styrene acrylates, styrene methacrylates, butadienes, isoprene, acrylonitrile, acrylic acid, methacrylic acid, beta-carboxy ethyl acrylate, polyesters, poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, and the like or a mixture thereof. In embodiments, the resin or polymer is a styrene/butyl acrylate/carboxylic acid terpolymer.

For example, the resin selected in embodiments is present in various effective amounts, such as for example, from about 62 weight percent to about 83 weight percent of toner, and the latex particle size is, for example, from about 0.05 micron to about 1 micron in average volume diameter as measured by the Brookhaven nanosize particle analyzer. Other sizes and effective amounts of latex particles may be selected in embodiments.

For example, in embodiments, the latex resins selected for the present process are prepared by emulsion polymerization methods, and the monomers utilized in such processes include, for example, styrene, acrylates, methacrylates, butadiene, isoprene, acrylonitrile, acrylic acid, and methacrylic acid, although not limited. Known chain transfer agents, for example dodecanethiol in effective amounts of, for example, from about 0.1 to about 10 percent, and/or carbon tetrabromide in effective amounts of from about 0.1 to about 10 percent, can also be employed to control the resin molecular weight during the polymerization. Other processes of obtaining resin particles of from, for example, about 0.05 micron to about 1 micron can be selected from polymer microsuspension processes, such as the processes disclosed in U.S. Pat. No. 3,674,736, the disclosure of which is totally incorporated herein by reference, polymer solution microsuspension process, such as disclosed in U.S. Pat. No. 5,290,654, the disclosure of which is totally incorporated herein by reference, mechanical grinding processes, or other known processes.

In embodiments, at least one of the non cross linked resin and cross linked resin or gel comprises carboxylic acid in an amount of about 0.05 to about 10 weight percent based upon the total weight of the non cross linked resin or cross linked resin or gel.

Surfactants

Surfactants in amounts of, for example, from about 0.01 to about 20, or about 0.1 to about 15 weight percent of the reaction mixture in embodiments include, for example, nonionic surfactants such as dialkylphenoxypoly(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. An effective concentration of the nonionic surfactant is in embodiments, for example, from about 0.01 to about 10 percent by weight, or from about 0.1 to about 5 percent by weight of the reaction mixture.

Examples of anionic surfactants include, for example, sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™ available from Kao, and the like. An effective concentration of the anionic surfactant generally employed is, for example, from about 0.01 to about 10 percent by weight, or from about 0.1 to about 5 percent by weight of the reaction mixture

Examples of bases used to increase the pH and hence ionize the aggregate particles thereby providing stability and preventing the aggregates from growing in size are selected from sodium hydroxide, potassium hydroxide, ammonium hydroxide, cesium hydroxide and the like.

Examples of the additional surfactants, which may be added optionally to the aggregate suspension prior to or during the coalescence to, for example, prevent the aggregates from growing in size, or for stabilizing the aggregate size, with increasing temperature can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™ available from Kao, and the like. These surfactants can also be selected from nonionic surfactants such as, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhone-Poulenac as IGEPAL CA-210™, IGEPAL CA-520™, IGEPAL CA-72™, IGEPAL CO-890™, IGEPAL CO-720™, IGEPAL CO-290™, IGEPAL CA-210™, ANTAROX 890™and ANTAROX 897™. An effective amount of the anionic or nonionic surfactant generally employed as an aggregate size stabilization agent is, for example, from about 0.01 to about 10 percent or from about 0.1 to about 5 percent, by weight of the reaction mixture.

Examples of the acids that can be utilized include, for example, nitric acid, sulfuric acid, hydrochloric acid, acetic acid, citric acid, trifluro acetic acid, succinic acid, salicylic acid and the like, and which acids are utilized in embodiments in a diluted form in the range of about 0.5 to about 10 weight percent by weight of water or in the range of about 0.7 to about 5 weight percent of water.

Wax

For example, wax suitable for the present toner compositions include, but are not limited to, alkylene waxes having about 1 to about 25 carbon atoms including, for example, polyethylene, polypropylene or mixtures thereof. Examples of waxes include those as illustrated herein, such as those of the aforementioned co-pending applications, polypropylenes and polyethylenes commercially available from Allied Chemical and Petrolite Corporation, wax emulsions available from Michaelman Inc. and the Daniels Products Company, Epolene N-15™ commercially available from Eastman Chemical Products, Inc., Viscol 550-P™, a low weight average molecular weight polypropylene available from Sanyo Kasei K.K., and similar materials. The commercially available polyethylenes possess, it is believed, a molecular weight Mw of from about 1,000 to about 5,000, and the commercially available polypropylenes are believed to possess a molecular weight of from about 4,000 to about 10,000. Examples of functionalized waxes include amines, amides, for example Aqua Superslip 6550™, Superslip 6530™ available from Micro Powder Inc., fluorinated waxes, for example Polyfluo 190™, Polyfluo 200™, Polyfluo 523XF™, Aqua Polyfluo 411™, Aqua Polysilk 19™, Polysilk 14™ available from Micro Powder Inc., mixed fluorinated, amide waxes, for example Microspersion 19™ also available from Micro powder Inc., imides, esters, quaternary amines, carboxylic acids or acrylic polymer emulsion, for example Joncryl 74™, 89™, 130™, 537™, and 538™, all available from SC Johnson Wax, chlorinated polypropylenes and polyethylenes available from Allied Chemical and Petrolite Corporation and SC Johnson Wax.

In embodiments, the wax comprises a wax dispersion comprising a wax having a volume average particle diameter of about 100 to about 500 nanometers, water, and an anionic surfactant. The wax is included in amounts such as from about 3 to about 30 weight percent or about 5 to about 15 weight percent based upon the total weight of the composition. The wax comprises in embodiments polyethylene wax particles, such as Polywax 850™, commercially available from Baker Petrolite, although the disclosure is not limited thereto, having a particle diameter in the range of about 100 to about 500 nanometers. The surfactant used to disperse the wax is in embodiments an anionic surfactant, although not limited thereto, such as, for example, Neogen RK™ commercially available from Kao or TAYCAPOWDER BN 2060 available from Tayca Corporation.

Conductive Colorant

Examples of conductive colorants or pigments suitable for the present toner process include, but are not limited to, pigments, dyes, mixtures of pigment and dye, mixtures of pigments, mixtures of dyes, and the like. The conductive colorant may have a color of, for example, black (e.g., carbon black), cyan, yellow, magenta, blue, or mixtures thereof. In embodiments, the conductive colorant comprises a pigment, a dye, carbon black, magnetite, black, cyan, magenta, yellow, red, green, blue, brown, or mixtures thereof, in an amount of, for example, about 1% to about 25% by weight based upon the total weight of the composition wherein a total of the components of the composition is about 100%.

Examples of conductive colorants that may be used include, but are not limited to, magnetites such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYERROX 8600™, 8610™; Northern Pigments magnetites, NP-604™, NP-608™; Magnox magnetites TB-100™, or TMB-104™. A suitable black pigment that may be used is, for example, carbon black such as REGAL 330™ and the like. As colored pigments, there can be selected pigments of cyan, magenta, yellow, red, green, brown, blue, or mixtures thereof. Specific examples of pigments include phthalocyanine HEILIOGEN BLUE L6900™, D6840™, D7080™, D7020™, PYLAM OIL BLUE™, PYLAM OIL YELLOW™, PIGMENT BLUE 1™, available from Paul Uhlrich & Company, Inc.; PIGMENT RED 48™, LEMON CHROME YELLOW DCC1026™, E.D. TOLUIDINE RED™, and BON RED C™, available from Dominion Color Corporation, Ltd., Toronto, Ontario; NOVAPERM YELLOW FGL™, HOSTAPERM PINK E™, available from Hoechst; and CINQUASIA MAGENTA™, available from E.I. DuPont de Nemours & Company, and the like. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyan pigments include copper tetra (octadecyl sulfonamide) phthalocyanine, x-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows that may be selected are diarylide yellow 3,3-dichlorobenzidene acetoacetamilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. The colorant may also be comprised of a predispersed pigment such as are commercially available. Example pigment dispersions include the FLEXIVERSE series and the SUNSPERSE series of pigment dispersions from Sun Chemical. Some of these are Blue 15:3 (BFD-1121), Blue 15 (BFD-1149), Blue 61 (BFD-9516), Red 81:2 (RFD 9664), Red 22 (RFD-4241), Yellow 14 (YFD-1123), Yellow 17 (YFD-4249), Black Regal 660 (LFD-4343), Green 7 (GFD-1151), Green 36 (GFD-7114), Violet 19 (QFD-1180) and Violet 23 (VFD-1157).

For example, in embodiments, the colorant comprises black pigment. In further embodiments, the colorant comprises carbon black. In still further embodiments, the pigment comprises black toner particles having a shape factor of about 120 to about 140, a circularity of about 0.900 to about 0.980, or a combination thereof.

In general, useful colorants or pigments in addition to carbon black include Paliogen Black L9984 9BASF), Pigment Black K801 (BASF) and carbon blacks such as REGAL 330 (Cabot), Carbon Black 5250 and 5750 (Columbian Chemicals), and the like or mixtures thereof. Additional useful colorants include pigments in water based dispersions such as those commercially available from Sun Chemical, for example FLEXIVERSE LFD 4343 and LFD 9736 (Pigment Black 7 77226) and the like or mixtures thereof. Other useful water based colorant dispersions include those commercially available from Clariant, for example, HOSTAFINE Black T and Black TS.

Coagulant

Coagulants used in the present process comprise poly metal halides, such as polyaluminum chloride (PAC) or polyaluminum sulfo silicate (PASS). The coagulants provide a final toner having a metal content of, for example, about 400 to about 10,000 parts per million. In another feature, the coagulant comprises a poly aluminum chloride providing a final toner having an aluminum content of about 400 to about 10,000 parts per million.

Preparation of Non Cross Linked Latex

A non cross linked latex comprising styrene, butylacrylate, and beta-carboxy ethyl acrylate (beta-CEA) monomers, termed herein as monomers A, B, and C, is prepared for example by emulsion polymerization in the presence of an initiator, a chain transfer agent (CTA), and surfactant. For example, the composition of the monomers is in embodiments about 70% to about 90% styrene, about 73% to about 85% styrene, or about 76.5% styrene, about 10% to about 30% butyl acrylate, about 15% to about 27% butyl acrylate, or about 23.5% butyl acrylate, and about 0.5% to about 10% beta-CEA, about 1.0% to about 5% beta-CEA, or about 3% beta-CEA, although not limited to these particular types of monomers or ranges.

The initiator may be, for example, but is not limited to, sodium or ammonium persulfate, and is present in the range of about 0.5 to about 3.0 percent based upon the weight of the monomers, although not limited. The CTA is present for example in an amount of from about 1.5 to about 3.0 percent by weight based upon the combined weight of the monomers A and B, although not limited. The surfactant is for example an anionic surfactant present in the range of about 0.7 to about 5.0 percent by weight based upon the weight of the aqueous phase, although not limited to this type or range.

For example, the monomers are polymerized under starve fed conditions such as referred to U.S. Pat. Nos. 5,444,140 and 5,455,315, the disclosures of which are hereby incorporated by reference herein in their entireties, to provide latex resin particles having a size in the range of about 100 to about 300 nanometers in size. The molecular weight of the latex resin is about 30,000 to about 37,000 although not limited to this range. The onset glass transition temperature (TG) is not limited but may be in the range, for example, of from about 46° C. to about 60° C. or about 51° C. In embodiments, the amount of carboxylic acid groups is in the range of about 0.05 to about 4.0 parts per hundred of the resin monomers A and B. The onset Tg of the polymer resin obtained is about 51° C., although not limited thereto, the molecular weight (Mw) is about 30,000 to about 37,000 or about 34,000, and the molecular number (Mn) is about 5,000 to about 20,000 to about 11,000, although not limited thereto, to provide a non cross linked latex having a pH of about 1.0 to about 4.0 or about 2.0.

Preparation of Cross Linked Latex Gel

For example, a cross linked latex is prepared from a non cross linked latex comprising styrene, butylacrylate, beta-CEA, and divinyl benzene, termed herein as monomers A, B, C, and D, by emulsion polymerization, in the presence of an initiator such as a persulfate, a CTA, and surfactant. The monomer composition comprises in embodiments about 60% to about 75% styrene or about 65% styrene, about 25% to about 40% butylacrylate or about 35% butylacrylate, about 3% to about 5% beta-CEA or about 3% beta-CEA, and about 3% to about 5% divinyl benzene or about 1% divinyl benzene, although the composition is not limited to these amounts. The Tg (onset) of the cross linked latex is about 40° C. to about 55° C. or about 42° C. and the degree of cross linking is in the range of about 0.3 to about 20 percent, although not limited thereto, since an increase in the divinyl benzene concentration will increase the cross linking. The soluble portion of the cross linked latex has in embodiments a Mw of about 135,000 and a Mn of about 27,000, but is not limited thereto. The particle size of the cross linked latex is about 50 nanometers, although not limited, and can be in the range of about 20 to about 250 nanometers. The surfactant may be any surfactant, such as, but not limited to, an anionic surfactant such as Neogen RK or TAYCAPOWDER BN 2060. The pH of the latex is about 1.5 to about 3.0 or about 1.8.

Preparation of Wax Dispersion

In embodiments, the wax is in the form of a dispersion comprising a wax having a particle diameter of about 100 to about 500 nanometers, water, and an anionic surfactant. For example, a wax dispersion is prepared in which the wax comprises in embodiments polyethylene wax particles, such as Polywax 850 commercially available from Baker-Petrolite, although not limited thereto, having a particle diameter in the range of about 100 to about 500 nanometers, although not limited. In aspects, the surfactant used to disperse the wax is an anionic surfactant, although not limited thereto, such as, for example, TAYCAPOWDER BN 2060 commercially available from Tayca Corporation.

Preparation of Carbon Black Dispersion

In embodiments, a colorant comprises a pigment dispersion comprising pigment particles having a volume average particle diameter of about 50 to about 300 nanometers, water, and an anionic surfactant. For example, a carbon black dispersion is prepared such as with Regal 330™ commercially available in an anionic surfactant and optionally a non-ionic dispersion to provide pigment particles having a size of from about 50 nanometers to about 300 nanometers. The surfactant used to disperse the carbon black is in embodiments an anionic surfactant such as Neogen RK™ or Taycapowder, although not limited thereto. An ultimizer type equipment is used to provide the pigment dispersion, although media mill or other means can also be used.

Toner Particle Preparation

Emulsion/aggregation/coalescing processes for the preparation of toners are illustrated in a number of Xerox patents, the disclosures of each of which are totally incorporated herein by reference, such as U.S. Pat. No. 5,290,654, U.S. Pat. No. 5,278,020, U.S. Pat. No. 5,308,734, U.S. Pat. No. 5,370,963, U.S. Pat. No. 5,344,738, U.S. Pat. No. 5,403,693, U.S. Pat. No. 5,418,108, U.S. Pat. No. 5,364,729, and U.S. Pat. No. 5,346,797. Also of interest are U.S. Pat. Nos. 5,348,832; 5,405,728; 5,366,841; 5,496,676; 5,527,658; 5,585,215; 5,650,255; 5,650,256; 5,501,935; 5,723,253; 5,744,520; 5,763,133; 5,766,818; 5,747,215; 5,827,633; 5,853,944; 5,804,349; 5,840,462; 5,869,215; 5,863,698; 5,902,710; 5,910,387; 5,916,725; 5,919,595; 5,925,488; and 5,977,210, the disclosures of each of which are totally incorporated herein by reference. In addition, Xerox patents of interest include U.S. Pat. Nos. 6,627,373; 6,656,657; 6,617,092; 6,638,677; 6,576,389; 6,664,017; 6,656,658; and 6,673,505, each of which are totally incorporated herein by reference. The appropriate components and process aspects of each of the foregoing may be selected for the present process in embodiments thereof.

In embodiments, the toner process comprises forming a toner particle by mixing the non cross linked latex with a quantity of the cross linked latex in the presence of a wax and pigment dispersion to which is added a coagulant of a poly metal halide such as polyaluminum chloride while blending at high speeds such as with a polytron. The resulting mixture having a pH of about 2.0 to about 3.0 is aggregated by heating to a temperature below the resin Tg to provide toner size aggregates. Additional non cross linked latex is added to the formed aggregates providing a shell over the formed aggregates. The pH of the mixture is then changed by the addition of a sodium hydroxide solution until a pH of about 7.0 is achieved. When the mixture reaches a pH of about 7.0, the carboxylic acid becomes ionized to provide additional negative charge on the aggregates thereby providing stability and preventing the particles from further growth or an increase in the grain size distribution when heated above the Tg of the latex resin. The temperature of the mixture is then raised to about 95° C. After about 30 minutes, the pH of the mixture is reduced to a value sufficient to coalesce or fuse the aggregates to provide a composite particle upon further heating such as about 4.5. The fused particles are measured for shape factor or circularity, such as with a Sysmex FPIA 2100 analyzer, until the desired shape is achieved.

The mixture is allowed to cool to room temperature and is washed. A first wash is conducted such as at a pH of about 10 and a temperature of about 63° C. followed by a De-Ionized Water (DIW) wash at room temperature. This is followed by a wash at a pH of about 4.0 at a temperature of about 40° C. followed by a final DIW water wash. The toner is then dried.

In the present toner composition comprising a non cross linked latex, a cross linked latex, a wax, and a pigment, the cross linked latex is primarily used to increase the hot offset, while the wax is used to provide release characteristics. The ratio of the non cross linked latex to the cross linked latex, the wax content and the pigment content are selected to control the rheology of the toner. In one embodiment, the toner comprises about 62 percent to about 82 percent non cross linked resin, about 6 percent to about 13 percent cross linked resin or gel, about 6 percent to about 12 percent wax, and about 6 percent to about 13 percent colorant, based upon the total weight of the composition. In another embodiment, the toner comprises about 71 percent non cross linked resin, about 10 weight percent cross linked resin, about 9 weight percent wax, and about 10 weight percent pigment, based upon the total weight of the composition. In another embodiment, the toner comprises a shape factor (Shape factor=100*Max diameter²/(Area*π/4)) of about 120 to about 140. In another embodiment, the toner comprises a particle circularity of about 0.900 to about 0.980. In yet another embodiment, the composite toner particle has a molecular weight of about 25,000 to about 40,000 or about 35,000, a molecular number of about 9,000 to about 13,000 or about 10,000, and an onset Tg of about 48° C. to about 62° C. or about 54° C. In another embodiment, the non cross linked resin comprises about 76.5 weight % styrene, about 23.5 weight % butylacrylate, and about 3.0 weight % beta-CEA, based upon the total weight of the non cross linked resin and the cross linked latex comprises about 65 weight % styrene, about 35 weight % butylacrylate, about 3 weight percent beta-CEA, and about 1.0 weight percent divinyl benzene based upon the total weight of the cross linked resin.

The following examples are set forth as representative of the present toner composition and process. These examples are not to be construed as limiting the scope of the present disclosure as these and other equivalent embodiments will be apparent in view of the present disclosure and accompanying claims.

Preparation of Non Cross Linked Latex by Emulsion Polymerization

For example, a latex emulsion designated as EP5 comprising polymer particles generated from the emulsion polymerization of styrene, n-butyl acrylate, and beta-CEA was prepared as follows. A surfactant solution consisting of about 605 grams Dowfax 2A1™ anionic emulsifier and 387 kg deionized water was prepared by mixing for about 10 minutes in a stainless steel holding tank. The holding tank was then purged with nitrogen for about 5 minutes before transferring into a reactor. The reactor was then continuously purged with nitrogen while being stirred at about 100 rpm. The reactor was then heated to about 75° C. at a controlled tare and held at about 75° C. for the entire reaction until cooling or which is about 6 to about 7 hours for the main part of the reaction. Separately, about 6.1 kg of ammonium persulfate initiator was dissolved in about 30.2 kg of deionized water. The monomer emulsion was prepared separately as follows. about 311.4 kg of styrene, about 95.6 kg of butyl acrylate, about 12.21 kg of beta-CEA, about 2.88 kg of 1-dodecanethiol, 1.42 kg of ADOD, about 8.04 kg of Dowfax 2A1™ anionic surfactant, and about 193 kg of deionized water were mixed to form an emulsion. About 1% of the formed emulsion was then slowly fed into the reactor containing the aqueous surfactant phase at about 75° C. to form the seeds while being purged with nitrogen. The initiator solution was then slowly charged into the reactor. After about 20 minutes, the rest of the emulsion was continuously fed into the reactor using a metering pump. Once all of the monomer emulsion was charged into the main reactor, the temperature was held at about 75° C. for an additional about 3 hours to complete the reaction. Full cooling was then applied and the reactor temperature was reduced to about 35° C. The resultant product was collected into a holding tank and then dried. The molecular properties of the latex after drying were as follows: Mw=35,419; Mn=11,354; onset Tg=51.0° C.

Preparation of Cross Linked Latex by Emulsion Polymerization

For example, a latex emulsion designated EA15-8 comprising polymer gel particles generated from the semi-continuous emulsion polymerization of styrene, n-butyl acrylate, divinyl benzene, and beta-CEA was prepared as follows. A surfactant solution consisting of 1.75 kilograms Neogen RK™ anionic emulsifier and 145.8 kilograms deionized water was prepared by mixing for about 10 minutes in a stainless steel holding tank. The holding tank was then purged with nitrogen for about 5 minutes before transferring into the reactor. The reactor was then continuously purged with nitrogen while being stirred at about 300 rpm. The reactor was then heated to about 75° C. at a controlled rate and held constant. In a separate container, about 1.24 kilograms of ammonium persulfate initiator was dissolved in about 13.12 kilograms of deionized water. In a second separate container, the monomer emulsion was prepared as follows. about 47.39 kilograms of styrene, about 25.52 kilograms of n-butyl acrylate, about 2.19 kilograms of beta-CEA, and about 729 grams of 55% grade divinyl benzene, about 4.08 kilograms of Neogen RK™ anionic surfactant, and about 78.73 kilograms of deionized water were mixed to form an emulsion. The ratio of styrene monomer to n-butyl acrylate monomer was about 65 to about 35 percent by weight. About 1.5% of the formed emulsion was slowly fed into the reactor containing the aqueous surfactant phase at about 75° C. under nitrogen purge to form seeds. The initiator solution was then slowly charged into the reactor and allowed to rest for about 20 minutes. After the about 20 minutes rest, the remainder of the emulsion was continuously fed into the reactor using metering pumps. Once all of the monomer emulsion was charged into the main reactor, the temperature was held at about 75° C. for an additional about 4 hours to complete the reaction. Full cooling was then applied and the reactor temperature was reduced to about 35° C. The product was collected into a holding tank after filtering through a 1 micron filter pad. After drying a portion of the latex, the molecular properties were measured to be as follows: Mw=134,700; Mn=27,300; onset Tg=43° C. The average particle size of the latex as measured with a Disc Centrifuge was 48 nanometers. The residual monomer as measured by gas chromatography was less than about 50 parts per million for styrene and less than about 100 parts per million for n-butyl acrylate.

Preparation of Toner

About 191.4 grams of EP5 latex having a solids loading of about 41.4 weight % and about 55.22 grams of EA Wax-91 wax emulsion (Polywax 850®) having a solids loading of about 30.07 weight % were added to about 478.6 grams of deionized water in a vessel and stirred using an IKA Ultra Turrax®T50 homogenizer operating at about 4,000 rpm. Thereafter, about 113.51 grams of black pigment dispersion Sun Pigment WA 1945 (Regal 330) having a solids loading of about 17 weight %, about 75 grams of EA15-8 latex gel having a solids loading of about 24 weight %, and about 9.91 grams of a 1 weight % calcium chloride solution was added to the above mixture followed by drop-wise addition of about 30.6 grams of a flocculent mixture containing about 3.06 grams polyaluminum chloride mixture and about 27.54 grams of a 0.02 molar (M) nitric acid solution. As the flocculent mixture was added drop-wise, the homogenizer speed was increased to about 5,200 rpm and homogenized for an additional about 5 minutes. Thereafter, the mixture was heated at a 1° C. per minute temperature increase to a temperature of about 49° C. and held there for a period of about 1.5 to about 2 hours resulting in a volume average particle diameter of about 5 microns as measured with a Coulter Counter. During the heat up period, the stirrer was run at about 250 rpm. About 10 minutes after the set temperature of about 49° C. was reached, the stirrer speed was reduced to about 220 rpm. An additional about 124.6 grams of EP5 latex was added to the reactor mixture and allowed to aggregate for an additional period of about 30 minutes at about 49° C. resulting in a volume average particle diameter of about 5.7 microns. The pH of the reactor mixture was adjusted to about 7 with a 1.0 M sodium hydroxide solution. The reactor mixture was then heated with a temperature increase of 1° C. per minute to a temperature of about 95° C. The pH of the mixture was then adjusted to about 3.7 with a 0.3 M nitric acid solution. The reactor mixture was then gently stirred at about 95° C. for about 5 hours to coalesce and spherodize the particles. The reactor heater was then turned off and the mixture was allowed to cool to room temperature at a rate of about 1° C. per minute. The resultant toner mixture was comprised of about 16.7% toner, about 0.25% anionic surfactant, and about 82.9% water by weight. The toner of this mixture comprised about 71 weight % styrene/acrylate polymer, about 10 weight % EA15-8 gel, about 10 weight % Regal 330 pigment, about 9 weight % PW850 wax, about 150 parts per million calcium chloride, had a volume average particle diameter of about 5.7 microns, and a GSD of about 1.19. The particles were washed 6 times, the first wash being conducted at a pH of about 10 at about 63° C., followed by 3 washes with deionized water at room temperature, followed by one wash at a pH of about 4.0 at about 40° C., and a final wash with deionized water at room temperature.

In embodiments, developer compositions are prepared by mixing the toners obtained with the present processes with known carrier particles, including coated carriers, such as steel, ferrites, and the like, reference U.S. Pat. Nos. 4,937,166 and 4,935,326, the disclosures of which are totally incorporated herein by reference, such as, for example from about 2 percent toner concentration to about 8 percent toner concentration. The carriers selected may also contain dispersed in the polymer coating a conductive compound, such as a conductive carbon black and which conductive compound is present in various suitable amounts, such as about 15 to about 65 or about 20 to about 45, weight percent.

In embodiments, a developer process is provided comprising preparing a developer comprising the composition as disclosed herein in embodiments and a carrier.

In embodiments, a process for preparing an image comprises employing the present compositions in an image forming device. In further embodiments, a process for preparing an image comprises employing the present compositions in an image forming device comprising a high speed printer, a black and white high speed printer, or a combination thereof.

Toners with Optimized Conductive Pigment Loading

In embodiments, the present toner composition provides a toner, preferably an emulsion aggregation toner, comprising a non cross linked resin; a cross linked resin or gel; wax; and conductive colorant, wherein the conductive colorant is present in an amount of from about 4% to about 18%, or about 6% to about 10%, or from about 8% to about 9%, by weight based upon the weight of the toner composition.

In embodiments, the toner composition provides a toner having a nominal transferred toner mass per area (TMA) of about 0.35 to about 0.55 mg/cm².

In embodiments, the toner composition provides a toner having a mottle grade of about 25 to about 35.

In embodiments, the toner composition provides a toner having a graininess mottle grade of about 4 to about 5.

In embodiments, the toner composition provides a toner having a nominal development voltage of about 200 V to about 300 V.

In embodiments, the toner composition provides a toner having a photoreceptor background of less than about 60 particles/mm².

In embodiments, the conductive pigment is present in an amount of about 6% to about 10%, or about 8% to about 9%, by weight, and provides excellent image quality while simultaneously reducing or eliminating undesirable charging effects. While not wishing to be bound by theory, the lower end of the range is associated with providing excellent image quality at a nominal TMA; that is, minimizing the nominal TMA for cost efficiency, while the upper end of the range is associated with the inductive charging effects as well as with undesirable reduction in triboelectric charge.

In embodiments, the toner composition has a molecular weight of about 25,000 to about 40,000. Further, the toner composition has in embodiments a molecular number of about 9,000 to about 13,000.

The following examples were prepared in accordance with the procedures as described above to illustrate aspects herein comprising optimized pigment loading. The base particles comprised styrene:butylacrylate:beta-CEA in a weight ratio of about 76.5% styrene, 23.5% butylacrylate, and about 3% beta-CEA, 10% cross linked gel latex, 9% PW850 wax, 0.17 pph polyaluminum chloride (PAC)-aggregating agent, and about 6 to about 10% carbon black pigment as listed in Table 1.

TABLE 1

| Example # | | 1 | 2 | 3 | 4 | 5 | 6 | 7 |
|---|---|---|---|---|---|---|---|---|
| Latex | | SDC-EP28 Emulsion polymerization latex | | | | | | |
| Gel Latex | | EA15-8 | | | | | | |
| Pigment | Dispersion | Sun dispersion | | | Cavitron dispersion | | | |
| | | WA1945 | | | PD-K7 | | | |
| | Loading | 6% | 8% | 10% | 6% | 8% | 9% | 10% |
| Particle | D50 | 5.77 | 5.64 | 5.62 | 5.71 | 5.72 | 5.75 | 5.59 |
| Size | GSDv | 1.19 | 1.19 | 1.19 | 1.19 | 1.19 | 1.20 | 1.19 |
| | GSDn | 1.23 | 1.22 | 1.22 | 1.23 | 1.22 | 1.23 | 1.23 |

In the Table 1, SDC-EP28 refers to emulsion polymerization latex lot number SDC-DP28 supplied by SDC, EA15-8 refers to the gel latex lot number described hereinabove (Preparation of cross linked latex by emulsion polymerization), Sun dispersion WA1945 refers to carbon black dispersion lot number from SUN Chemical, Cavitron dispersion PD-K7 refers to carbon black dispersion lot number PD-K7 available from XRCC. D50 refers to mean particle size, GSDv refers to Geometric Standard Deviation by volume, GSDn refers to Geometric Standard Deviation by number.

Preparation of Developer

A developer package was prepared with each of the toners described in Examples 1-7 including a powder-coated carrier comprising 35 micron spherical magnesium-strontium ferrite core (Powdertech Corp., Japan) and a surface additive package comprising about 1.71% hydrophobic 50 nanometer fumed silica, about 0.74% 120 nanometer hydrophobic sol-gel silica, and about 0.37% hydrophobic 40 nanometer titania as described in commonly assigned, co-pending, U.S. patent application of Mary L. McStravick; Paul C. Julien; Sue E. Blaszak; and William H. Hollenbaugh, Jr. entitled “Emulsion Aggregation Developer Design For High Speed Printing Which Provides Superior Image Quality And Large Process Latitude With SCMB Development,” Ser. No. ______, Attorney Docket Number Xerox ID A21716, filed Sep. 11, 2002, which is hereby incorporated by reference herein in its entirety.

Xerographic Development

A mixture of about 400 grams of carrier and about 24 grams of toner was placed into the developer housing of a Xerox DC 12 printer. TMA was measured by blowing unfused toner off and weighing the substrate with and without the toner. q/d was measured in a charge spectrograph by visual measurements of the low and high limits of toner deflection from the zero-field dot position. Background on the photoreceptor was collected on an adhesive tape, and the number of particles per mm² was counted using a laboratory optical microscope.

Fusing

Unfused solid area and halftone images with a size of 1 inch×2 inches were prepared with a DC12 printer on a Xerox 4024 paper substrate. These images were fused in a Xerox DT120 fuser. The process speed was set to 829 mm/s and the nip width was kept at 13.5 mm. All of the samples were fused with the roll temperature set to 185° C.

Image Quality Analysis

Xerox Corporation IQAF (Xerox Corporation proprietary image quality analysis package) was used to measure solid area density, mottle and graininess. The image quality results are summarized in the Table 2.

TABLE 2

| Dispersion Type | | Sun | | | Cavitron | | | | |
|---|---|---|---|---|---|---|---|---|---|
| CB % | Target | 6 | 8 | 10 | 6 | 8 | 9 | 10 | CB loading ranges |
| q/d, fC/μm (A-zone, | < −0.2 | −0.40 | −0.32 | −0.29 | '0.34 | −0.26 | | −0.32 | Target met for all |
| 60 min paint-shake) | | | | | | | | | CB loadings |
| q/d, fC/μm (C-zone, | < −0.2 | −1.26 | −1.02 | −0.99 | −1.32 | −0.94 | | −0.89 | Target met for all |
| 60 min paint-shake) | | | | | | | | | CB loadings |
| Mottle (maximum) at | 40 | ND | ND | ND | 25 | 35 | 30 | 30 | Target met at |
| TMA = 0.4 mg/cm2 | | | | | | | | | nominal TA for |
| | | | | | | | | | all CB loadings |
| Graininess | 5 | ND | ND | ND | 4.1 | 4.8 | 5.0 | 5.1 | <10% is required |
| (maximum) at TMA = | | | | | | | | | to meet the target |
| 0.4 mg/cm2 | | | | | | | | | |
| Development voltage, | <300 | 450 | 230 | 250 | 320 | 255 | 280 | 270 | >6% is required |
| V | | | | | | | | | to meet the target |
| Photoreceptor | <60 | <15 | 37 | 65 | 10 | 38 | 56 | 72 | <10% is required |
| background, | | | | | | | | | to meet the target |
| particles/mm2 | | | | | | | | | |
| Waste bottle fill rate | <8 | ND | 1 | 14 | ND | ND | ND | ND | <10% is required |
| (DC555), g/kiloprint | | | | | | | | | to meet the target |

In Table 2, q/d in femto-coulombs per micro-meter was evaluated using the above charge spectrograph procedure, A zone=85% RH and 28° Celsius, and C zone=15% RH and 10° Celsius.

All toners have very similar charging characteristics. q/d changes in a range of −1.32 to −0.26 however remains below the target value of −0.2 fC/micron even at the highest loading of carbon black (CB) colorant. Mottle is low, within about 25 to about 35 range (visible mottle is 40-50 and higher). Photoreceptor background increases with CB loading (due to electrical induction); however it remains within the range of <60 particles/mm² up to about 10% CB. Therefore, the range of CB loadings, about 6 to about 9%, is sufficiently low to prevent undesirable reduction in triboelectric charge and undesirable induction background, and sufficiently high for good image quality.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A toner composition comprising:
a resin substantially free of cross linking;
a cross linked resin;
a wax; and
a conductive colorant.

2. The toner composition of claim 1, wherein the conductive colorant is present in an amount of about 4% to about 18% by weight based upon the total weight of the toner composition and wherein the total of the components is about 100%.

3. The toner composition of claim 1, wherein the conductive colorant has a volume average particle diameter of about 50 to about 300 nanometers.

4. The toner composition of claim 1, wherein the conductive colorant comprises a pigment, a dye, carbon black, magnetite, black, cyan, magenta, yellow, red, green, blue, brown, or mixtures thereof.

5. The toner composition of claim 1, wherein the conductive colorant comprises carbon black present in an amount of about 6% to about 10% by weight based upon the total weight of the toner composition and wherein the total of the components is about 100%.

6. The toner composition of claim 1, wherein the conductive colorant comprises carbon black present in an amount of about 8% to about 9% by weight based upon the total weight of the toner composition and wherein the total of the components is about 100%.

7. The toner composition of claim 1, wherein the toner provides a nominal transferred toner mass per area of about 0.35 to about 0.55 mg/cm².

8. The toner composition of claim 1, wherein the toner provides a mottle grade of about 25 to about 35.

9. The toner composition of claim 1, wherein the toner provides a graininess of about 4 to about 5.

10. The toner composition of claim 1, wherein the toner provides a nominal development voltage of about 200 V to about 300 V for monochrome applications.

11. The toner composition of claim 1, wherein the toner provides a photoreceptor background of less than about 60 particles per square millimeter for monochrome applications.

12. The toner composition of claim 1, wherein the conductive colorant possesses a conductivity of about 1×10⁻⁶ S/cm to about 1×10⁴ S/cm.

13. The toner composition of claim 1, wherein the conductive colorant possesses a conductivity of about 1×10⁻² S/cm to about 100 S/cm.

14. The toner composition of claim 1, wherein the conductive colorant comprises a pigment dispersion comprising pigment particles having a volume average particle diameter of about 50 to about 300 nanometers, water, and an anionic surfactant.

15. The toner composition of claim 1, having about 68% to about 75% resin substantially free of cross linking, about 6% to about 13% cross linked resin, about 6% to about 12% wax, and about 4% to about 18% conductive colorant, by weight based upon the total weight of the composition and wherein the total of said components is about 100%.

16. The toner composition of claim 1, wherein the resin substantially free of cross linking comprises a non cross linked resin having substantially about zero percent cross linking to about 0.1 percent cross linking

17. The toner composition of claim 1, wherein the resin substantially free of cross linking and the cross linked resin are selected from the group consisting of styrene acrylates, styrene methacrylates, butadienes, isoprene, acrylonitrile, acrylic acid, methacrylic acid, beta-carboxy ethyl acrylate, polyesters, poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), and poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, or mixtures thereof.

18. The toner composition of claim 1, wherein the wax is an alkylene having about 1 to about 25 carbon atoms.

19. The toner composition of claim 18, wherein the alkylene comprises polyethylene, polypropylene, or mixtures thereof.

20. The toner composition of claim 1, wherein the wax is in the form of a dispersion comprising a wax having a volume average particle diameter of about 100 to about 500 nanometers, water, and an anionic surfactant.

21. A developer comprising the toner composition of claim 1; and
a carrier.

22. A xerographic device comprising a charging component, an imaging component, a photoconductive component, a developing component, a transfer component, and a fusing component, and wherein the development component comprise the developer of claim 21.

23. The device of claim 22, wherein the device for preparing an image comprises a high speed printer, a black and white high speed printer, a color printer, or combinations thereof.

24. A process for preparing a toner comprising:
mixing a resin substantially free of cross linking and a cross linked resin in the presence of a wax, a conductive colorant, and coagulant to provide toner size aggregates;
adding additional resin substantially free of cross linking to the formed aggregates thereby providing a shell over the formed aggregates;
heating the shell covered aggregates to form toner; and
optionally, isolating the toner.

25. The process of claim 24, wherein the heating comprises a first heating below the glass transition temperature of the resin substantially free of cross linking and a second heating above the glass transition temperature of the resin substantially free of cross linking.

26. The process of claim 24, wherein the conductive colorant is present in an amount of about 4% to about 18% by weight based upon the total weight of the toner composition and wherein the total of said components is about 100%.

27. The process of claim 24, wherein the toner provides a nominal transferred toner mass per area of about 0.35 to about 0.55 mg/cm2.

28. The process of claim 24, wherein the toner provides a mottle grade of about 25 to about 35.

29. The process of claim 24, wherein the toner provides a graininess of about 4 to about 5.

30. The process of claim 24, wherein the toner provides a nominal development voltage of about 200 V to about 300 V for monochrome applications.

31. The process of claim 24, wherein the toner provides a photoreceptor background of less than about 60 particles per square millimeter for monochrome applications.

32. The toner process of claim 24, further comprising:
providing an anionic surfactant in an amount of about 0.01% to about 20% by weight based upon a total weight of the reaction mixture;
wherein the anionic surfactant is selected from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof.

33. The toner process of claim 24, wherein the shell has a thickness of about 0.3 to about 0.8 micrometers.

34. An imaging process comprising:
developing an image on a photoreceptor with the toner composition of claim 1.
